(19) United States
(12) Patent Application Publication
(10) Pub. No.: US 2024/0052861 A1
(43) Pub. Date: Feb. 15, 2024

(54) CLIP APPARATUS

(71) Applicant: FF AWAY, LLC, NORTH BABYLON, NY (US)

(72) Inventor: JEFFREY D. MCCOY, NORTH BABYLON, NY (US)

(73) Assignee: FF AWAY, LLC, NORTH BABYLON, NY (US)

(21) Appl. No.: 18/232,778

(22) Filed: Aug. 10, 2023

Related U.S. Application Data
(60) Provisional application No. 63/396,640, filed on Aug. 10, 2022.

(51) Int. Cl. F16B 2/22; A01M 1/20

(52) U.S. Cl. CPC F16B 2/22; A01M 1/20; A01M 1/00

(57) ABSTRACT

A clip apparatus having multiple planar surfaces configured for the engagement of a pest strip is disclosed. Certain planar surfaces are arranged at an angle to a base planar surface in order to accommodate the pest strip and to keep the pest strip from being dislodged. The clip apparatus enables pest strip deployment on walls and within trash receptacles.

### CROSS-REFERENCE TO RELATED APPLICATIONS AND PRIORITY CLAIMS

This patent application is a Non-Provisional patent application which claims priority under 35 U.S.C. § 119(e) to U.S. Provisional Patent Application Ser. No. 63/396,640, titled “CLIP APPARATUS” filed Aug. 10, 2022. The entire disclosure of the aforementioned provisional patent application is incorporated by reference into this non-provisional patent application as if fully stated herein.

### FIELD OF THE INVENTION

The present invention relates in general to an apparatus for holding vapor or pest strips in place.

### BACKGROUND OF THE INVENTION

Insecticides may be deployed for use in different forms, including, as pest strips. These strips may be deployed in a number of ways, including hanging from the ceiling. However, there exists a need for deployment of pest strips onto walls or trash receptacles.

Accordingly, aspects of embodiments of the present invention contemplate a clip apparatus which enables pest strip deployment onto walls or within trash receptacles. These aspects enable installation in environments or situations where installation of the pest strips were previously not possible.

In an aspect of an embodiment of the present invention, the clip apparatus enables the pest strip to be installed onto walls and within trash receptacles, including, without limitation, trash receptacle lids. Aspects of embodiment of embodiments of the present invention also contemplate hanging installations using aspects of the contemplated invention. In an aspect of an embodiment of the present invention, the pest strip may be slid in place in the clip apparatus nd replaced once expired or once the insecticide is finished. The clip apparatus securely holds the pest strip in place allowing the vapors to be released.

### SUMMARY OF THE INVENTION

In an aspect of an embodiment of the present invention, the clip apparatus may be made of plastic. It should be noted that the clip apparatus may be made of different materials as well.

An aspect of an embodiment of the present invention contemplates the clip apparatus having a flat side onto which double-sided tape may be applied. The flat side is the side that would adhere to a flat deployment surface by way of the double-sided tape. Use of the double-sided tape is illustrative only as different means of deployment are also contemplated.

An aspect of an embodiment of the present invention contemplates a clip apparatus, which may include: a base planar surface, where the base planar surface comprises of a first end and a second end, a first end planar surface extending at an angle from the first end of the base planar surface, where the first end planar surface comprises of a bottom end and a top end, where the bottom end represents where or the point of connection between the first planar surface and the first end of the base planar surface (where the first planar surface extends from the first end of the base planar surface) and where the top end is at an opposite end in relation to the bottom end. The clip apparatus may also include a second end planar surface extending at an angle from the second end of the base planar surface, where the second end planar surface comprises of a bottom end and a top end, where the bottom end represents where the second planar surface extends from the second end of the base planar surface and where the top end is at an opposite end in relation to the bottom end, a first secondary planar surface extending from the first planar surface at a location between the top and bottom ends of the first planar surface, a second secondary planar surface extending from the second planar surface at a location between the top and bottom ends of the second planar surface, a first tertiary planar surface extending at an angle from the top end of the first end planar surface, and a second tertiary planar surface extending at an angle from the top end of the second end planar surface.

In an aspect of an embodiment of the present invention, any one or more of the: base planar surface, first end planar surface, second end planar surface, first secondary planar surface, second secondary planar surface, first tertiary planar surface, and second tertiary planar surface of the clip apparatus may be rectangular in shape.

In an aspect of an embodiment of the present invention, the angle between the first end planar surface and the base planar surface and the angle between the second end planar surface and the base planar surface may be any one of: 90 degrees or less than 90 degrees.

In an aspect of an embodiment of the present invention, the angle between the first end planar surface and the base planar surface and the angle between the second end planar surface and the base planar surface may be equal to each other.

In an aspect of an embodiment of the present invention, the angle between the first secondary planar surface and the first end planar surface may be any one of: 90 degrees or less than 90 degrees.

In an aspect of an embodiment of the present invention, angle between the second secondary planar surface and the second end planar surface may be either 90 degrees or less than 90 degrees.

In an aspect of an embodiment of the present invention, the first secondary planar surface and the first tertiary planar surface may each be shorter than the base planar surface's length.

In an aspect of an embodiment of the present invention, each of the first and second end planar surfaces may be arms that protrude or extend from the base planar surface (or the flat surface) at a slight angle. In addition, each of the first and second end planar surfaces may include two ridges which create a slot for the pest strip to slide into. The angle of the arms provides tension that will hold the pest strip securely in place. The slot may be slightly raised from the flat side (or the base planar surface) in order to allow the vapors from the pest strip to be adequately released.

One advantage of the contemplated invention is that the clip apparatus may securely hold any sized pest strip. Another advantage is that the clip apparatus increases the amount of treatment spaces that could be targeted with a pest strip.

The clip apparatus as contemplated by aspects of embodiments of the present invention, may be applied to any hard, flat surface. It could also be applied to walls for whole room treatment. It further may be applied to trash receptacles lids for trash receptacle treatment.

### PARTS/ELEMENTS

100 Clip Apparatus
102 Base Planar surface
102A First End of Base Planar Surface
102B Second End of Base Planar Surface
102C Midpoint of Base Planar Surface
104 First End Planar Surface
104A Bottom End of First End Planar Surface
104B Top End of First End Planar Surface
104C First Tertiary Planar Surface
104D First Secondary Planar Surface
106 Second End Planar Surface
106A Bottom End of Second End Planar Surface
106B Top End of Second End Planar Surface
106C Second Tertiary Planar Surface
106D Second Secondary Planar Surface

### LIST OF DRAWINGS

FIG. 1 illustrates a top perspective view of a clip apparatus according to an aspect of an embodiment of the present invention.

FIG. 2 illustrates another top perspective view of a clip apparatus according to an aspect of an embodiment of the present invention.

FIG. 3 illustrates another top perspective view of a clip apparatus showing a vapor/pest strip deployer within same, according to an aspect of an embodiment of the present invention.

FIG. 4 illustrates an end view of a clip apparatus according to an aspect of an embodiment of the present invention.

### DETAILED DESCRIPTION OF DRAWINGS

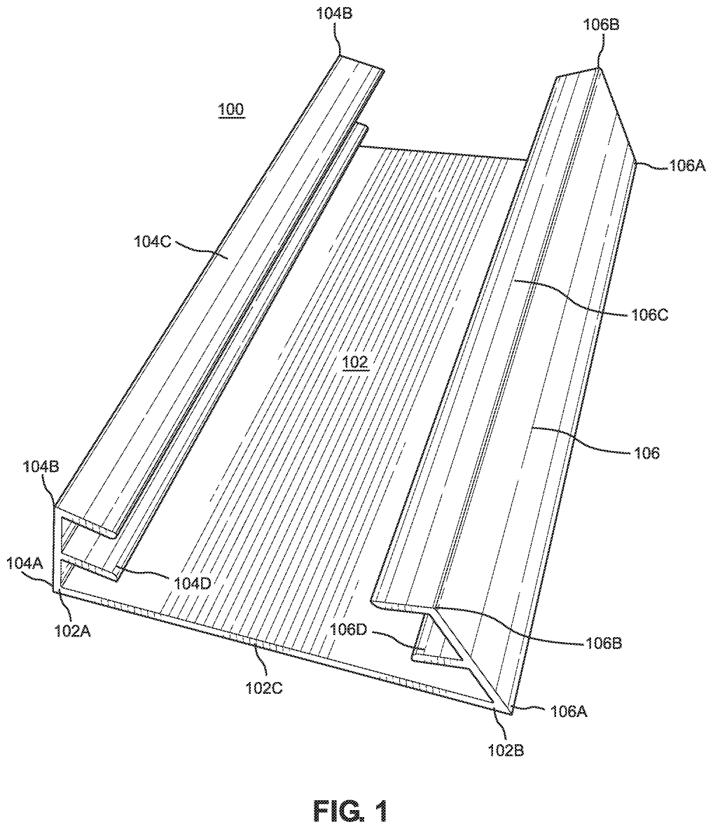

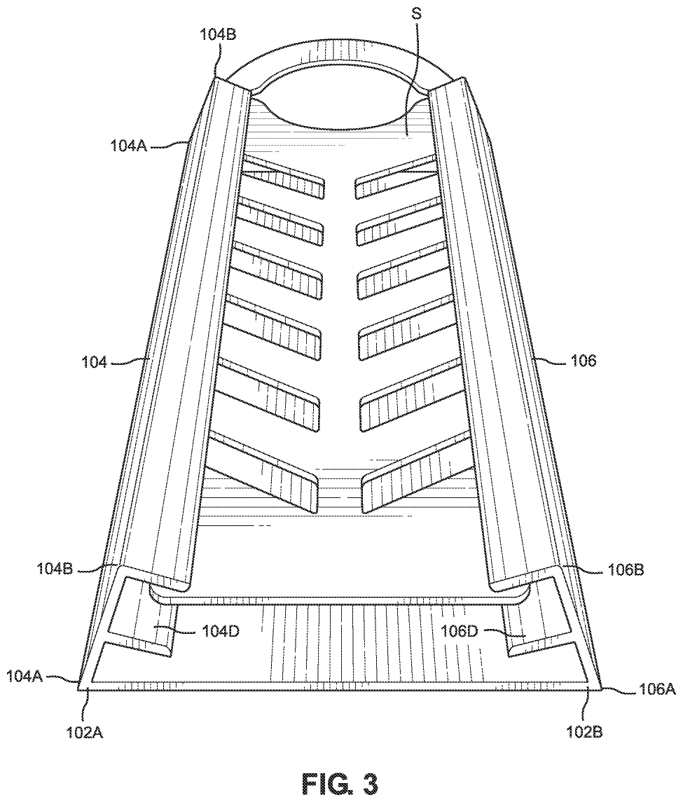

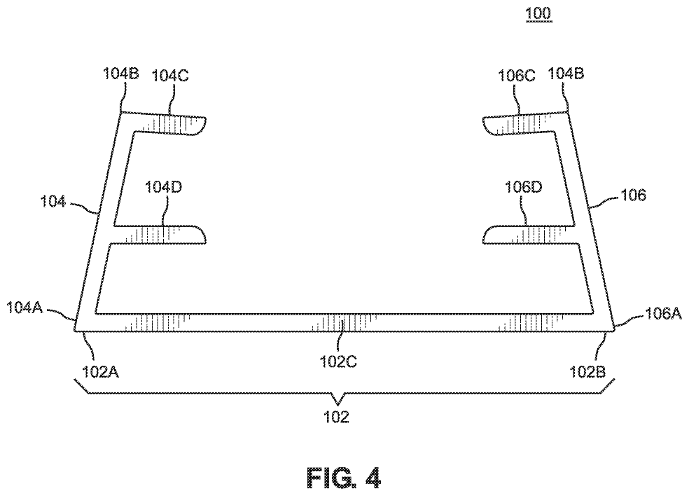

Referring now to FIGS. 1-4, clip apparatus 100 is shown according to aspects of embodiments of the present invention. In an aspect of an embodiment of the present invention, clip apparatus 100 may include base planar surface 102, where base planar surface 102 may, in an aspect of an embodiment of the present invention, comprise of first end 102A and second end 102B.

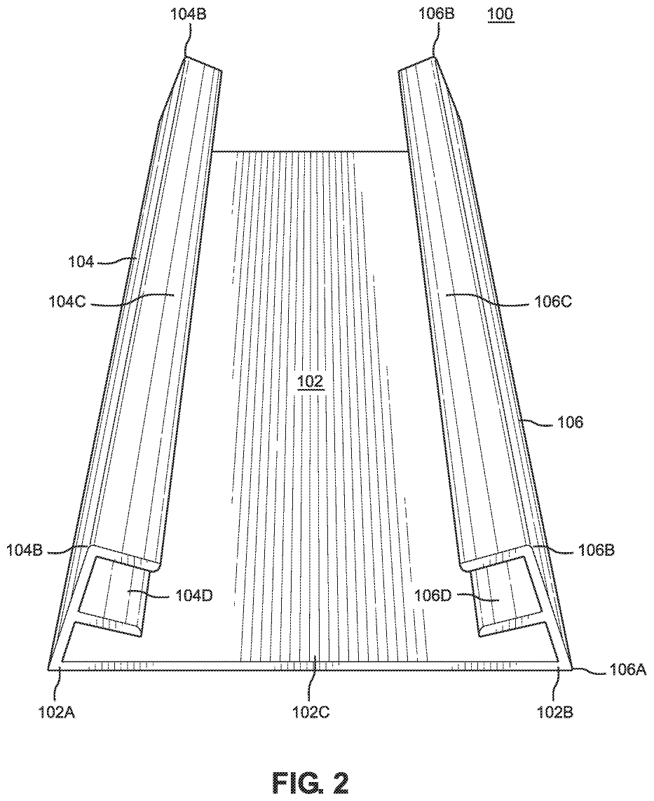

Clip apparatus 100 may also include first end planar surface 104 (FIGS. 2-4) extending at an angle from first end 102A of base planar surface 102, where first end planar surface 104 comprises of bottom end 104A and top end 104B. In an aspect of an embodiment of the present invention, first end planar surface 104 may extend lengthwise along the length of base planar surface 102.

In an aspect of an embodiment of the present invention, bottom end 104A of first end planar surface 104 is the location where first planar surface 104 extends from first end 102A of base planar surface 102. Top end 104B of first end planar surface 104 may be located opposite bottom end 104A of first end planar surface 104.

Clip apparatus 100 may also include second end planar surface 106 which extends at an angle from second end 102B of base planar surface 102. In an aspect of an embodiment of the present invention, second end planar surface 106 comprises of bottom end 106A and top end 106B. In an aspect of an embodiment of the present invention, bottom end 106A represents where second planar surface 106 extends from second end 102B of base planar surface 102. In another aspect of an embodiment of the present invention, top end 106B may be located at an opposite end in relation to bottom end 106A.

Clip apparatus 100 may also include first secondary planar surface 104D extending from first end planar surface 104 at a location between top and bottom ends 104B and 104A of said first end planar surface 104.

Clip apparatus 100 may also include second secondary planar surface 106D extending from second end planar surface 106 at a location between top and bottom ends 106B and 106A of second end planar surface 106.

Clip apparatus 100 may further include first tertiary planar surface 104C extending at an angle from top end 104B of first end planar surface 104. Clip apparatus 100 may also include second tertiary planar surface 106C extending at an angle from top end 106B of second end planar surface 106.

In an aspect of an embodiment of the present invention, the angle between first end planar surface 104 and base planar surface 102 and the angle between second end planar surface 106 and base planar surface 102 may be either 90 degrees, or less than 90 degrees

In an aspect of an embodiment of the present invention, the angle between first end planar surface 104 and base planar surface 102 and the angle between second end planar surface 106 and base planar surface 102 may be equal to each other.

In an aspect of an embodiment of the present invention, the angle between first secondary planar surface 104D and first end planar surface 104 may be either 90 degrees, or less than 90 degrees.

In an aspect of an embodiment of the present invention, the angle between second secondary planar surface 106D and second end planar surface 106 may be either 90 degrees, or less than 90 degrees.

In an aspect of an embodiment of the present invention, first secondary planar surface 104D and first tertiary planar surface 104C may each be shorter than base planar surface 102's length.

In an aspect of an embodiment of the present invention, either of, or both of, first end planar surface 104 and second end planar surface 106, may be inclined towards the midpoint 102C of base planar surface 102.

In an aspect of an embodiment of the present invention, any one or more of base planar surface 102, first end planar surface 104, second end planar surface 106, first secondary planar surface 104D, second secondary planar surface 106D, first tertiary planar surface 104C, and second tertiary planar surface 106C may be rectangular in shape.

In an aspect of an embodiment of the present invention where first end planar surface 104 may be rectangular in shape, top and bottom ends 104B and 104A of first end planar surface 104, may represent the edges of first end planar surface 104.

In another aspect of an embodiment of the present invention where base planar surface 102 may be rectangular in shape, first and second ends 102A and 102B of base planar surface 102 may represent the edges of base planar surface 102.

In a further aspect of an embodiment of the present invention where second end planar surface 106 may be rectangular in shape, top and bottom ends 106B and 106A of second end planar surface 106 may represent the edges of second end planar surface 106.

Although this present invention has been disclosed with reference to specific forms and embodiments, it will be evident that a considerable number of variations may be made without departing from the spirit and scope of the present invention. For example, structural elements may be reversed, equivalent elements may be substituted for those specifically disclosed and certain features of the present invention may be used independently of other features—all without departing from the present invention as outlined above, in the appended figures and the claims presented below.

What is claimed is:

1. A clip apparatus, comprising:
a base planar surface, wherein said base planar surface comprises of a first end and a second end;
a first end planar surface extending at an angle from said first end of said base planar surface, wherein said first end planar surface comprises of a bottom end and a top end, wherein said bottom end represents where said first planar surface extends from said first end of said base planar surface and wherein said top end is at an opposite end in relation to said bottom end;
a second end planar surface extending at an angle from said second end of said base planar surface, wherein said second end planar surface comprises of a bottom end and a top end, wherein said bottom end represents where said second planar surface extends from said second end of said base planar surface and wherein said top end is at an opposite end in relation to said bottom end;
a first secondary planar surface extending from said first planar surface at a location between said top and bottom ends of said first planar surface;
a second secondary planar surface extending from said second planar surface at a location between said top and bottom ends of said second planar surface;
a first tertiary planar surface extending at an angle from said top end of said first end planar surface; and
a second tertiary planar surface extending at an angle from said top end of said second end planar surface.

2. The clip apparatus of claim 1, wherein any one or more of said: base planar surface, first end planar surface, second end planar surface, first secondary planar surface, second secondary planar surface, first tertiary planar surface, and second tertiary planar surface is rectangular in shape.

3. The clip apparatus of claim 1, wherein said angle between said first end planar surface and said base planar surface and said angle between said second end planar surface and said base planar surface is any one of: 90 degrees, less than 90 degrees

4. The clip apparatus of claim 1, wherein said angle between said first end planar surface and said base planar surface and said angle between said second end planar surface and said base planar surface are equal to each other.

5. The clip apparatus of claim 1, wherein said angle between said first secondary planar surface and said first end planar surface is any one of: 90 degrees, less than 90 degrees.

6. The clip apparatus of claim 1, wherein said angle between said second secondary planar surface and said second end planar surface is any one of: 90 degrees, less than 90 degrees.

7. The clip apparatus of claim 1, wherein said first secondary planar surface and said first tertiary planar surface are each shorter than said base planar surface's length.
